(19) United States
(12) Patent Application Publication
(10) Pub. No.: US 2006/0060031 A1
(43) Pub. Date: Mar. 23, 2006

(54) Broken bolt extractor apparatus and method

(76) Inventor: Ron Morris, Valley Springs, AR (US)

Correspondence Address: RICHARD J. POE, 391 HWY 286 E, CONWAY, AR, 72032, US

(21) Appl. No.: 10/948,551

(22) Filed: Sep. 23, 2004

(51) Int. Cl. B25B 13/50

(52) U.S. Cl. 81/53.2

(57) ABSTRACT

A method of removing broken bolts that avoids applying additional radial pressure at the thread area between the broken bolt and the object from which the broken bolt is desired to be removed. This method consists of drilling and tapping the broken bolt through its long axis with a thread that is opposite to the thread on the circumference of the broken bolt. Tapping is preferably accomplished with a special tap having a shoulder at the shank-thread junction that makes positive contact with the top of the broken bolt. As this contact is made, continued rotation to drive the tap further into the bolt will normally cause the broken bolt to begin unthreading due to the threads being opposite to that of the tap. If it appears that the tap may break before the broken bolt begins to unthread, the tap is remove and a special bolt having the same thread form and size as the tap is threaded into the broken bolt. The special bolt like the special tap has a shoulder at the thread-shank junction such that when it comes in contact with the top of the broken bolt it acts with further continued rotation to cause the broken bolt to unthread due to the threads being opposite.

### BACKGROUND OF THE INVENTION

1. Field of the Invention

This invention was conceived as an improvement over prior art methods employed in the removal of broken bolts.

2. Description of the Related Art

The present method of removing broken bolts is to drill a hole through the long axis of the portion of the bolt remaining in the object from which removal is desired. The head of such bolt having been fractured off. Then either in combination with the drill or separately, a tool is inserted into the drilled out portion of the broken bolt and rotated manually with a wrench or otherwise in the direction so as to “thread out” the broken bolt. Such tools have a set of spiral flutes that bind against the inside of the drilled out portion of the broken bolt which exert pressure laterally outward to lock the tool to the bolt. This process, by exerting this outward force, can cause a problem by forcing the broken bolt to expand and become even more firmly lodged.

### SUMMARY OF THE PRESENT INVENTION

The present invention solves the problem by not exerting the outward pressure that causes the broken bolt to expand and become more tightly wedged in place. The inventive method starts with drilling a hole through the long axis as in the related art but the hole is of appropriate size for accepting a thread tap. The drilled hole is then threaded with a special thread tap with threads of the opposite rotation to the broken bolt. The special thread tap has a shoulder such that as the tap has threaded to a sufficient depth into the broken bolt the shoulder makes firm contact against the broken bolt. By applying rotational force to the shank of the tap, the tap and the broken bolt acts as one unit to cause the broken bolt to unthread from the object from which removal is desired because the thread on the broken bolt is opposite in rotation to the thread on the tap into the broken bolt.

### BRIEF DESCRIPTION OF THE DRAWINGS

FIG. 1 is a sectional view of the broken bolt, tap drill, and object from which removal of the broken bolt is desired.

FIG. 2 is a sectional view of the broken bolt, special tap, and object from which removal of the broken bolt is desired, all in full engagement.

FIG. 3 is a sectional view of the broken bolt, special bolt, and object from which removal of the broken bolt is desired, all in full engagement.

FIG. 4 is a side view of a special tap for effecting the inventive method.

FIG. 5 is a side view of a special bolt for effecting the inventive method.

### DESCRIPTION OF THE PREFERRED EMPODIMENT

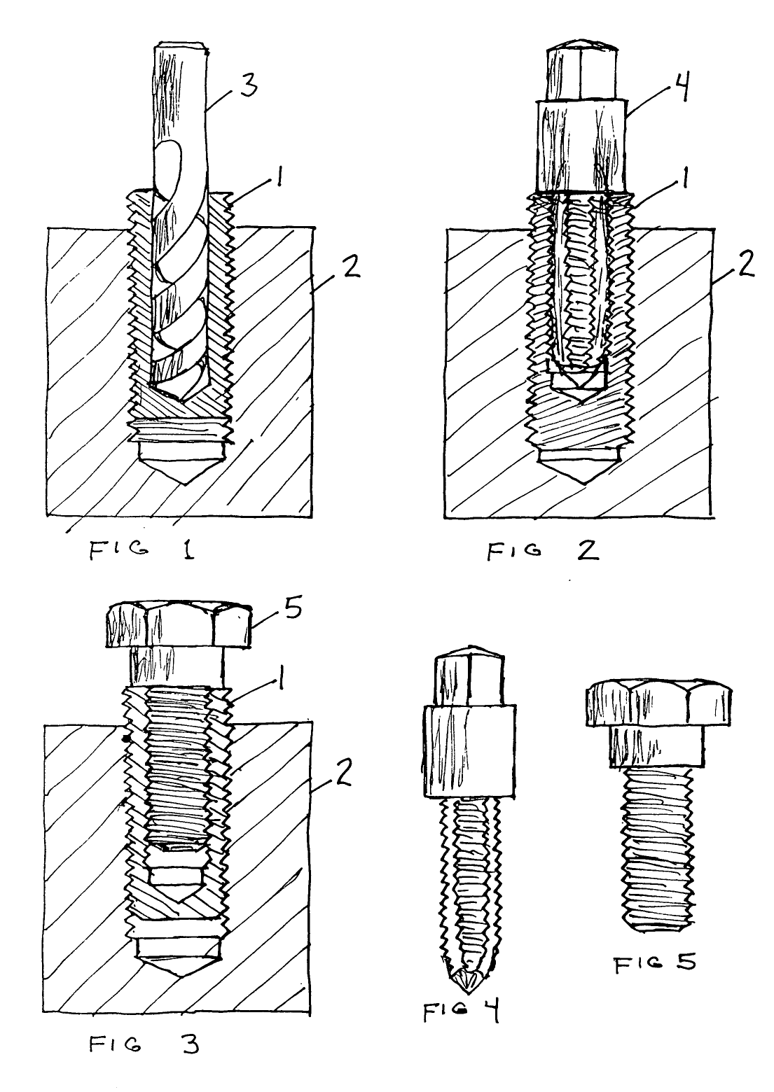

FIG. 1 shows the broken bolt 1 engaged in the object 2 from which the removal of the broken bolt 1 is desired with a tap drill 3 engaged in broken bolt 1. This depicts the first step of the invented method which is the tap drilling of the broken bolt 1.

FIG. 2 shows the broken bolt 1 engaged in the object 2 from which the removal of the broken bolt 1 is desired with special tap 4 having a thread lead rotation opposite that of the thread lead rotation on the outer circumference of broken bolt 1 with special tap 4 threadedly engaged in broken bolt 1. As the shoulder of special tap 4 contacts the upper surface of broken bolt 1 relative rotation between special tap 4 and broken bolt 1 will cease and applying additional rotational force in the direction that advanced special tap 4 into broken bolt 1 will now be applied to special tap 4 and broken bolt 1 together. Since the thread lead rotation of the original thread on the outer circumference of broken bolt 1 is in the opposite direction to that of special tap 4 such continued rotational force would be applied in the direction such as to cause the broken bolt to unthread from the object from which it is desired to be removed. This depicts the second step of the inventive method.

If broken bolt 1 does not threadedly disengage from object 2 when modest rotational force is applied to special tap 4 then it is better to move to a third step rather than risk breaking special tap 4 and thus entrapping the broken portion of special tap 4 within broken bolt 1.

FIG. 3 shows special bolt 5 engaged in broken bolt 1 for the purpose of applying a greater rotational force to effect the removal of broken bolt 1 and is a depiction of the third step.

Special tap 4 and special bolt 5 are unique because of the shoulder at the junction of the threaded portion and the adjacent shank portion on both special tap 4 and special bolt 5. Such shoulder can result from making the shank larger in diameter than the threaded portion or by having a collar affixed to the shank portion adjacent the threaded portion.

It is this shoulder contacting the broken bolt that best facilitates the inventive method. The use of standard taps and bolts will frequently fail to yield positive results, while the use of the special tap 4 in step two is often sufficient to do the job without requiring the use of special bolt 5 in step three.

It is contemplated that broken bolt removal kits will be made available in various size ranges for removing various sizes of broken bolts. Such kits would normally contain a tap drill, special tap 4, and special bolt 5.

While the best mode contemplated for carrying out the invention has been explained in this preferred embodiment it will be apparent that modifications and variations of this method may be made without departing from what is the subject matter of this invention.

What is claimed:

1. A method of removing a broken threaded bolt from an object from which removal of said broken threaded bolt is desired comprising the steps of
drilling a hole through the longitudinal axis of the broken threaded bolt of a diameter appropriate to accept a thread tap
tapping the said drilled hole in said broken threaded bolt with an appropriate size tap of opposite thread lead rotation to that of the thread on the circumference of said broken threaded bolt
applying modest rotational force to said thread tap in the direction of rotation to feed the tap into said broken threaded bolt to determine if such modest force will begin to rotate the broken threaded bolt in the same direction and cause the opposite thread lead on said broken threaded bolt to start said broken threaded bolt backing out of the object from which removal is desired.

2. A method as in claim 1 whereby after tapping the drilled hole in the broken threaded bolt with a tap of opposite thread lead rotation to that of said broken threaded bolt, said tap is removed from said broken threaded bolt and a threaded bolt of the same thread form, lead rotation, and size as said tap is threaded into said broken threaded bolt and sufficient rotational force is applied to said threaded bolt of tap size to loosen and threadedly remove said broken threaded bolt.

3. A special thread tap for removing broken threaded bolts that have been drilled through the long axis with a tap drill of appropriate size comprised of
a portion of the length from one end of the special tap having a thread cutting capability and
having the portion of the special tap adjacent to the thread of a diameter larger than the thread cutting portion so as to form a shoulder at the junction of the thread cutting portion and the adjacent larger diameter portion and
having at the distal end of the shank portion opposite the thread cutting portion a squared, hexed or other shape so as to receive a wrench for the purpose of applying rotational force.

4. A special threaded bolt for removing a broken threaded bolt that has been drilled and tapped through the long axis with thread lead rotation opposite that of said broken threaded bolt comprised of
a portion of the length from one end of the special threaded bolt threaded with a thread of the same form, lead rotation, and size as the hole tapped in said broken threaded bolt desired to be removed and
having the portion adjacent to the threaded portion of a larger diameter such that it forms a shoulder at the junction of the threaded portion and the adjacent shank portion and
having on the shank portion at the distal end from the threaded portion a head of hexed, square, or other shape so as to accept a wrench for the purpose of applying rotational force.
